(19) United States
(12) Patent Application Publication
(10) Pub. No.: US 2025/0350368 A1
(43) Pub. Date: Nov. 13, 2025

(54) METHOD AND APPARATUS FOR DETERMINING CHARACTERISTICS OF EQUALIZATION-ENHANCED PHASE NOISE IN COHERENT OPTICAL COMMUNICATION SYSTEMS

(71) Applicant: Omattrix Ltd., Co., Santa Clara, CA (US)

(72) Inventors: Weiren PENG, Santa Clara, CA (US); Lung LAW, Santa Clara, CA (US)

(73) Assignee: Omattrix Ltd., Co., Santa Clara, CA (US)

(21) Appl. No.: 19/266,886

(22) Filed: Jul. 11, 2025

(51) Int. Cl. H04B 10/61

(52) U.S. Cl. CPC H04B 10/61

(57) ABSTRACT

The present disclosure generally relates to high-speed coherent communication, more particularly, relates to method and apparatus for determining characteristics of equalization enhanced phase noise (EEPN) in coherent optical communication systems. According to one aspect of the present disclosure, there is provided a method for determining characteristics of EEPN in a coherent optical communication system. The method comprise: acquiring operation parameters associated with EEPN of the coherent optical communication system are acquired; determining an accumulated dispersion coefficient for the coherent optical communication system based on the operation parameters; and determining a frequency-domain impulse response based on the accumulated dispersion coefficient and a frequency-domain signal related to a local oscillator of the coherent optical communication system.

### TECHNICAL FIELD

The present disclosure generally relates to high-speed coherent communication, more particularly, relates to method and apparatus for determining characteristics of equalization enhanced phase noise (EEPN) in coherent optical communication systems.

### BACKGROUND

Coherent communication is a core technology for achieving high-rate and high-spectral-efficiency transmission in modern optical and wireless communications. Through “coherent detection” (which utilizes the phase coherence between a local oscillator (LO) and a received signal to accurately extract the amplitude and phase information of the signal), it significantly improves the receiving sensitivity of the system and enables higher-order modulation schemes (such as QPSK, 16QAM, and other high-order modulations).

In high-speed coherent systems, signal transmission faces two substantial challenges:
1. Channel impairments such as dispersion and polarization mode dispersion (PMD) in optical fibers, or multipath effects in wireless channels. These impairments can cause inter-symbol interference (ISI), which severely affects signal demodulation.
2. Phase noise, typically stemming from the phase instability of local oscillators (e.g., random phase fluctuations caused by laser linewidth) and the spontaneous emission noise of optical amplifiers, etc. The noise can disrupt the phase matching in coherent detection, leading to constellation rotation and an increase in bit error rate (BER).

To compensate for the channel impairments, the coherent systems typically incorporate equalization technologies (such as digital equalizers), which eliminate interferences like ISI through filtering or weighting processing of the received signals. However, studies have found that the equalization process may “amplify” the impact of the phase noise, resulting in equalization-enhanced phase noise. This phenomenon limits the maximum transmission rate and distance of the system and is a critical issue that urgently needs to be addressed in the design of high-speed coherent systems.

### SUMMARY OF THE INVENTION

According to one aspect of the present disclosure, there is provided a method for determining characteristics of EEPN in a coherent optical communication system. The method comprises: acquiring operation parameters associated with EEPN of the coherent optical communication system are acquired; determining an accumulated dispersion coefficient for the coherent optical communication system based on the operation parameters; and determining a frequency-domain impulse response based on the accumulated dispersion coefficient and a frequency-domain signal related to a local oscillator of the coherent optical communication system.

In an embodiment according to the present disclosure, the operation parameters include dispersion coefficient, fiber length, and center optical frequency.

In an embodiment according to the present disclosure, the operation parameters are stored as configuration parameters at the receiver-side of the system.

In an embodiment according to the present disclosure, the accumulated dispersion coefficient is determined as:

$$k = π \cdot D \cdot l \cdot c \cdot {f}_{o}^{- 2}$$

where k denotes the accumulated dispersion coefficient, D denotes the dispersion coefficient, l denotes fiber length l, and f₀ denotes the center optical frequency.

In an embodiment according to the present disclosure, the frequency-domain impulse response is determined as:

$${H}_{E EPN , {t}_{c}} ( f ) = ( \frac{π}{k} ) \cdot {x}_{l o , {t}_{c}} ( f )$$

where H_{EEPN,t}_{_{c}}(f) denotes the frequency-domain impulse response, and x_{lo,t}_{_{c}}(f) denotes a frequency-domain signal related to the local oscillator.

In an embodiment according to the present disclosure, the method further comprises:
determining a pulse response based on the accumulated dispersion coefficient and the frequency-domain signal related to the local oscillator.

In an embodiment according to the present disclosure, the pulse response is determined as:

$${H}_{{t}_{c}}^{′} ( f ) \approx {H}_{E E P N , {t}_{c}} ( f ) \cdot {H}_{tx} ( f ) \cdot {e}^{j 2 π f {t}_{c}} \\ {H}_{tx} ( f ) = ℱ \{ {h}_{tx} ( t ) \}$$

where Hₜ_{_{c}}′(f) denotes the pulse response, Hₜₓ(f) denotes the frequency-domain response of the input pulse which is the Fourier transform of the input pulse hₜₓ(t), and e^{j2πft}^{_{c}} denotes a phase term.

In an embodiment according to the present disclosure, the method further comprises:
performing one or more of the following operations on distortions, noises, and system performance related to signal transmission in the coherent optical communication system based on the characteristics of EEPN: evaluation, compensation, monitoring, and optimization.

According to another aspect of the present disclosure, there is provided an apparatus for determining characteristics of EEPN in a coherent optical communication system, comprising:
a storage device configured to store a computer program comprising computer instructions; and
a processor coupled to the storage device and configured to execute the computer instructions to:
acquire operation parameters associated with EEPN of the coherent optical communication system are acquired;
determine an accumulated dispersion coefficient for the coherent optical communication system based on the operation parameters; and
determine a frequency-domain impulse response based on the accumulated dispersion coefficient and a frequency-domain signal related to a local oscillator of the coherent optical communication system.

### BRIEF DESCRIPTION OF THE DRAWINGS

The disclosure is herein described, by way of example only, with reference to the accompanying drawings. With specific reference now to the drawings in detail, it is stressed that the particulars shown are by way of example and for purposes of illustrative discussion of the preferred embodiments of the present disclosure only, and are presented in order to provide what is believed to be the most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice. In the drawings:

FIG. 1 shows a schematic diagram of a typical coherent optical communication system.

FIG. 2 shows a base band equivalent representation of a coherent optical communication system.

FIG. 3(a) shows phase response of the simulated pulse compared with the phase of the impulse response.

FIGS. 3(b) shows the amplitude profiles of the simulated pulse and an ideal RRC pulse for comparison.

FIG. 4 is a process flow diagram of a method for determining characteristics of EEPN in a coherent optical communication system according to one exemplary embodiment of the present disclosure.

FIG. 5 is a block diagram illustrating an apparatus for determining characteristics of EEPN in a coherent optical communication system according to one exemplary embodiment of the present disclosure.

### DETAILED DESCRIPTION

The principles and operation of the present disclosure may be better understood with reference to the drawings and accompanying description.

Before explaining at least one embodiment of the disclosure in detail, it is to be understood that the disclosure is not limited in its application to the details of construction and the arrangement of the components set forth in the following description or illustrated in the drawings. The disclosure is capable of being implemented by other embodiments or of being practiced or carried out in various ways. Also, it is to be understood that the phraseology and terminology employed herein is for the purpose of description and should not be regarded as limiting.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following detailed description and claims, the terms “coupled” and “connected”, along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

### Architecture of Coherent Optical Communication System

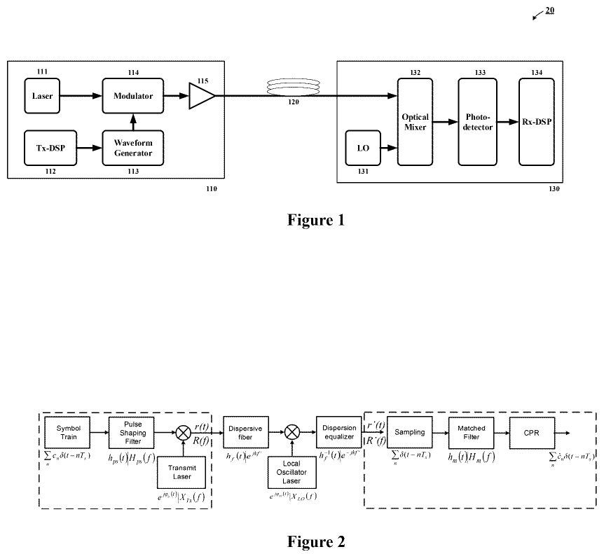

FIG. 1 shows a schematic diagram of a typical coherent optical communication system. The coherent optical communication system 10 shown in FIG. 1 includes an optical transmitter 110, an optical fiber channel 120, and an optical receiver 130. The optical transmitter 110 comprises a laser 111 as a light source, a transmitter-side digital signal processor (DSP) 112, a waveform generator 113, a modulator 114, and an optical fiber amplifier 115. At the transmitter, the DSP 112 processes the electrical domain data to be transmitted, such as mapping binary data to higher-order modulation constellation points (e.g., points on a 16QAM constellation diagram) and performing pre-compensation operations. The waveform generator 113 generates an analog signal to drive the modulator 114 based on the output of the DSP 112. Meanwhile, the laser carrier output by the laser 111 enters the modulator 114, where the amplitude and phase of the optical carrier are modulated according to the I and Q signals under the action of the drive signal from the waveform generator 113, loading the data onto the optical carrier. The modulated optical signal is then amplified by the optical fiber amplifier 115 before being injected into the optical fiber for transmission.

During transmission through the optical fiber channel 120, the optical signal experiences impairments such as dispersion and nonlinear effects (when optical power is high, nonlinear effects in the fiber distort the signal), which degrade the signal quality. The optical receiver 130 includes a local oscillator or local laser 131, an optical mixer 132, a photodetector 133, and a receiver-side DSP 134. At the receiver, the local reference light output by the local oscillator and the received signal light enter the optical mixer 132 together. In the optical mixer, the received signal light interferes with the local reference light, producing an interference optical signal that contains the amplitude and phase information of the signal light. This interference optical signal is converted into an electrical signal by the photodetector 133. The receiver-side DSP 134 first compensates for impairments such as dispersion and nonlinear effects introduced during fiber transmission, and then processes phase noise (caused by slight frequency differences and phase fluctuations between the transmit and receive lasers). The signal processed by the receiver-side DSP 134 is demodulated and mapped back to the original data, which is then accurately recovered through error correction decoding.

Currently, the evaluating of EEPN largely relies on numerical simulations or empirical models, which fail to accurately and concisely describe its dynamic characteristics and physical mechanisms. This makes it difficult to design targeted suppression strategies. Therefore, establishing an accurate model for EEPN is of great significance for optimizing system performance (such as reducing bit error rate and improving transmission rate).

### EEPN Model for Coherent Optical Receivers

### 1. Derivation

FIG. 2 shows a base band equivalent representation of a coherent optical communication system. In coherent digital communication, depending on modulation format, information is encoded in phase and/or amplitude to achieve high spectral efficiency, for each polarization. In the following analysis, without loss of generality, it considers a power normalized representation of the components, so that the net system gain remains unity, independent of the transmitted constellation. In general, the incoming bits are mapped on symmetrically distributed symbols cₙ in the complex plane, resulting in a symbol train at the rate R_{b}/m, where m is the number of bits encoded per symbol and Rb is the incoming bit rate. This symbol train with symbol period Tₛ=m/R_{b} is convoluted with a pulse shaping filter represented by the Fourier transform pair hₚₛ (t)|Hₚₛ (f) to generate a band limited continuous signal. The band limited signal is then modulated on the transmitting laser to generate the output signal. The stochastic base band equivalent representation of the transmitting laser before modulation can be written as e^{jφ}^{_{Tx}}^{(t)}|X_{Tx}(f). The base band equivalent output of the transmitter after modulation can similarly be represented asthe Fourier transform pair r(t)|R(f). The transmitter output passes through the all-pass dispersive fiber with response

$${h}_{f} ( t ) \vert {e}^{j k {f}^{2}}$$

and is finally coherently detected with an LO having stochastic base band equivalent response as e^{jφ}^{_{LO}}^{(t)k}|X_{LO}(f). This detected signal is oversampled (in a practical system), followed by dispersion equalization, down sampling and filtering with a low pass filter/optimally matched filter. Dispersion equalization is modeled as an inverse of the channel transfer function h_{f}⁻¹|e^{-jkf}^{²}. The received signal after dispersion equalization is given by the Fourier transform pair r′(t)|R′(f). The linear filtering has negligible impact on EEPN. Thus, without loss of generality, it can consider a matched filter response which is maximum at t=0 and null at t=nTₛ. Carrier phase recovery (CPR) is then performed on the received sampled signal followed by demodulation. It is important to note that CPR has no impact on EEPN, since EEPN is a complex additive noise generated due to intra and inter symbol interference. Thus, without loss of generality for the analysis, it considers ideal CPR which compensates for the pure phase noise, if any. Since convolution operation is associative with itself, we can interchange the order of the operations such as oversampling, dispersion equalization, down sampling and matched filtering. Also the convolution of oversampling and down sampling operation can be replaced by a single down sampling operation. Hence, without loss of generality, the processing after coherent reception can be modeled as shown in FIG. 2 where these functions are collected as a single block.

The frequency-domain response can be calculated as follows. To be specific, the received signal R′(f) after EDC in FIG. 2 is given by

$${R}^{′} ( f ) = [ R ( f ) \cdot {e}^{{jkf}^{2}} ⊗ {X}_{LO} ( f ) ] \cdot {e}^{- {jkf}^{2}} \qquad ( 1 )$$

where k=π·D·l·c·f₀⁻² is the accumulated dispersion factor, l is the fiber length, D is the dispersion coefficient, c is the speed of light and f₀ is the central optical frequency.

The time domain response of the received signal influenced by EEPN can be calculated by taking the inverse Fourier transform (IFT) of the frequency-domain response R′(f). The received signal r′(t) after EDC is then given by

$${r}^{′} ( t ) = {\int }_{- ∞}^{∞} {X}_{LO} ( {f}_{1} ) \cdot {e}^{- {jkf}_{1}^{2}} \cdot [ r ( t - \frac{{kf}_{1}}{π} ) \cdot {e}^{j 2 π {f}_{1} t} ] {df}_{1} \qquad ( 2 )$$

where X_{LO}(f) is the Fourier transform ( [symbol] ) of time-domain LO waveform xₗₒ(t)=e^{jθ(t)} with θ(t) representing the LO phase noise. The term k=π·D·l·c·fₒ⁻² denotes the accumulated dispersion factor, where D is the dispersion coefficient, l is the fiber length, c is the light speed in vacuum and fₒ is the central optical frequency. The function r(t) represents the transmitted signal. From Equation (2) it can be observed that the interference introduced by EEPN primarily manifests as multiple time-shifted replicas of the original signal r(t), each weighted by the corresponding sideband component of X_{LO}(f). The details on the derivation of equation (2) are described in A. Kakkar, J. R. Navarro, R. Schatz, et al., “Comprehensive study of equalization-enhanced phase noise in coherent optical systems”, J. Lightwave Technol. 33(23), 4834-4841 (2015), which is incorporated by reference in its entirety.

To examine the pulse response of EEPN, the transmitted signal r(t) is replaced with a single pulse hₜₓ(t−t_{c}) located at time t_{c} with a bandwidth of B, i.e.,

$${h}_{{t}_{c}}^{′} ( t ) = {\int }_{- ∞}^{∞} {X}_{LO} ( {f}_{1} ) \cdot {e}^{- {jkf}_{1}^{2}} \cdot {e}^{j 2 π {f}_{1} {t}_{c}} \cdot [ {h}_{tx} ( t - {t}_{c} - \frac{{kf}_{1}}{π} ) \cdot {e}^{j 2 π {f}_{1} ( t - {t}_{c} )} ] {df}_{1} \qquad ( 3 )$$

Physically, the phase term e^{-jkf}^{₁}^{²} will act on X_{LO}(f₁), which represents the LO spectrum that normally exhibits a very narrow bandwidth, and therefore can be reasonably ignored. Furthermore, the phase term e^{j2πf}^{₁}^{(t-t}^{_{c}}⁾ actually stands for temporal alignment between the LO waveform and the pulse, which is also physically negligible for a pulse duration. Therefore it is reasonable to remove both phase terms in Equation (3). Furthermore, the substitution t′=kf₁/π is introduced and thus Equation (3) can be as follows:

$${h}_{{t}_{c}}^{′} ( t ) \approx {\int }_{- ∞}^{∞} {X}_{LO} ( {f}_{1} ) {e}^{j 2 π {f}_{1} {t}_{c}} [ {h}_{tx} ( t - {t}_{c} - \frac{{kf}_{1}}{π} ) ] {df}_{1} = ( \frac{π}{k} ) {\int }_{- ∞}^{∞} {h}_{EEPN , {t}_{c}} ( {t}^{′} ) \cdot [ {h}_{tx} ( t - {t}_{c} - {t}^{′} ) ] {dt}^{′} \qquad ( 4 )$$

Equation (4) reveals that the EEPN output hₜ_{_{c}}′(t) can be obtained by convolving the input pulse hₜₓ with h_{EEPN,t}_{_{c}}(t)=(π/k)·X_{LO}(πt/k)·e^{j2π(πt/k)t}^{_{c}}, indicating that h_{EEPN,t}_{_{c}}(t) serves as the impulse response associated with EEPN. The corresponding frequency-domain impulse response H_{EEPN,t}_{_{c}}(f) can be obtained below:

$${H}_{EEPN , {t}_{c}} ( f ) = ( \frac{π}{k} ) \cdot {x}_{lo , {t}_{c}} ( f ) \qquad ( 5 )$$

where x_{lo,t}_{_{c}}(f) is a frequency-domain signal related to the local oscillator, which can be given by

$${x}_{lo , {t}_{c}} ( f ) = ℱ \{ {X}_{LO} ( π t / k ) \cdot {e}^{j 2 π ( π t / k ) {t}_{c}} \} = {ℱ}^{- 1} \{ {X}_{LO} ( - π t / k ) \cdot {e}^{- j 2 π ( π t / k ) {t}_{c}} \} = {x}_{lo} ( - \frac{kf}{π} - {t}_{c} ) \qquad ( 6 )$$

That is, x_{lo,t}_{_{c}}(f) is the Fourier transform (denoted by [symbol] ) for Fourier transform) of the time-domain signal X_{LO}(πt/k)·e^{j2π(πt/k)t}^{_{c}} and is also equal to the inverse Fourier transform (denoted by [symbol] ⁻¹) for inverse Fourier transform) of X_{LO}(−πt/k)·e^{-j2π(πt/k)t}^{_{c}}.

Ultimately, it simplifies to

$${x}_{lo} ( - \frac{kf}{π} - {t}_{c} ) .$$

Moreover, the corresponding pulse response Hₜ_{_{c}}′(f) can be obtained below:

$${H}_{{t}_{c}}^{′} ( f ) \approx {H}_{EEPN , {t}_{c}} ( f ) \cdot {H}_{tx} ( f ) \cdot {e}^{j2 π {ft}_{c}} \qquad ( 7 )$$

$${H}_{tx} ( f ) = ℱ \{ {h}_{tx} ( t ) \} \qquad ( 8 )$$

Thus, Hₜ_{_{c}}′(f) is approximately equal to the product of frequency-domain impulse response H_{EEPN,t}_{_{c}}(f), the frequency-domain response of the input pulse Hₜₓ(f), and the phase term e^{j2πft}^{_{c}}. Here, Hₜₓ(f) is the Fourier transform of the input pulse hₜₓ(t), i.e., the frequency-domain characteristic of the input pulse.

### 2. Verification

Equation (5) suggests that the phase of the output pulse in the frequency-domain should follow the LO phase noise waveform while Equation (7) indicates that the amplitude of the output pulse should remain unchanged from the input. In other words, the model as defined reveals that EEPN acts as a time-varying phase perturbation on each pulse, directly linked to a truncated segment of the LO phase noise.

To verify the above model, a simulation setup described below is built. To be specific, a root-raised cosine (RRC) pulse matched to a symbol rate of Rₛ=252 GBaud with a roll-off factor β=0.1 (corresponding to a bandwidth B=277 GHz) is sampled at 2Rₛ over a time window of approximately (2 kRₛ/T)≈81 ns, which is selected to be larger than the broadened pulse duration T_{CD}. The pulse is then passed through a chromatic dispersion (CD) block corresponding to 20 ns/nm dispersion, which broadens its duration to approximately T_{CD}=44.6 ns. The broadened pulse is subsequently multiplied by a LO waveform xₗₒ, modeled as a Wiener process with a linewidth of 150 kHz. Afterward, the signal is passed through an ideal CD compensator (i.e., the exact inverse of the CD block). The output waveform from this process is referred to as the simulated response (“Simu”).

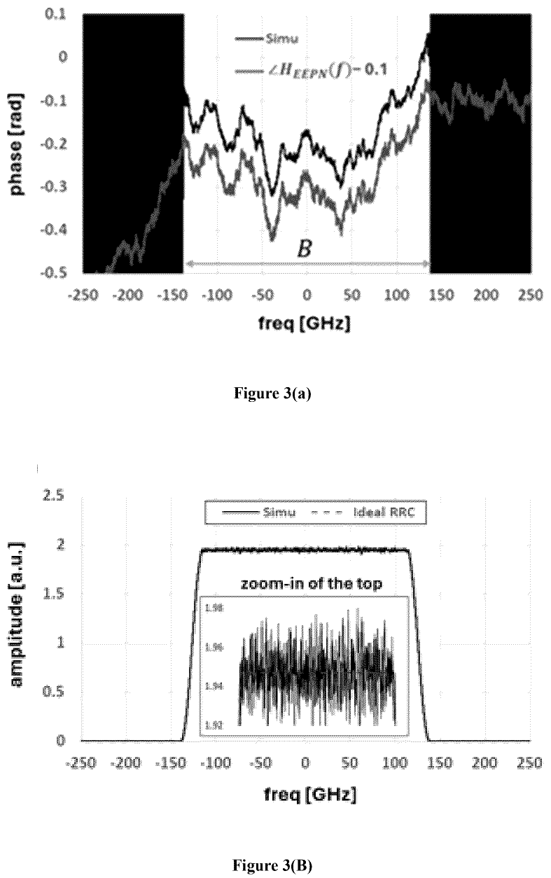

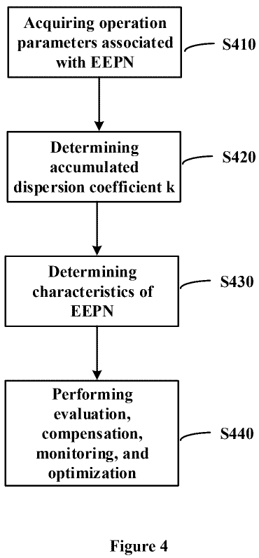

FIG. 3(a) shows phase response of the simulated pulse compared with the phase of the impulse response ∠H_{EEPN,t}_{_{c}}(f). An offset of ˜0.1 radians is added for visual clarity, as the two curves are nearly indistinguishable within the pulse bandwidth B. In FIG. 3(a), the spectral phase of the “Simu” response is shown and compared with the LO waveform function θ(−kf/π−t_{c}), which is offset by 0.1 radians for visual clarity. Within the pulse bandwidth, it is found that the phase of the “Simu” response closely follows the reference, therefore validating the model as described above. The rapid phase fluctuations of the “Simu” outside the passband correspond to spectral regions with negligible power and thus can be ignored.

FIGS. 3(b) shows the amplitude profiles of the simulated pulse and an ideal RRC pulse for comparison. In FIG. 3(b), the two exhibit nearly identical amplitude profiles, with a small difference in the passband. A zoomed-in view of this region, shown in the inset, confirms that the deviation is minor and can be reasonably neglected. That is, the difference between them is barely noticeable, except for a slight fluctuation at the top of the pulse.

The results as shown in FIGS. 3(a) and 3(b) confirm that both the phase and amplitude characteristics of the “Simu” frequency response are well modeled by Equations (5)˜(7), validating its correctness.

### Method for Determining Characteristics of EEPN

FIG. 4 is a process flow diagram of a method for determining characteristics of EEPN in a coherent optical communication system according to one exemplary embodiment of the present disclosure. For illustrative purpose, the following depiction is made in the context of the above architecture as shown in FIG. 1. However, one skilled artisan in the art would recognize that the present disclosure is applicable to other architectures. The steps described below can be executed at the receiver-side of the system shown in FIG. 1, or at an external device of the system. Hereinafter, the receiver-side of the system and the external device will be collectively referred to as the apparatus for determining characteristics of EEPN in a coherent optical communication system or the apparatus. Moreover, one skilled artisan will recognize that all of the aspects of the present disclosure as described above are applicable to the present exemplary embodiment.

With reference to FIG. 4, at step S410, the apparatus acquires operation parameters associated with EEPN of the coherent optical communication system. These parameters include, for example, the aforementioned dispersion coefficient D, fiber length l, and center optical frequency f₀. Illustratively, the parameters can be stored as configuration parameters at the receiver-side of the system (e.g., in memory of the receiver-side DSP 134).

Subsequently, in step S420, the apparatus determines an accumulated dispersion coefficient k for the coherent optical communication system based on the acquired operation parameters. Illustratively, this coefficient k can be determined as:

$$k = π \cdot D \cdot l \cdot c \cdot {f}_{o}^{- 2} \qquad ( 9 )$$

Then, proceeding to step S430 where the apparatus determines the characteristics of EEPN based on the accumulated dispersion coefficient k and a frequency-domain signal related to the local oscillator x_{lo,t}_{_{c}}(f). The characteristics of EEPN described herein include, for example, a frequency-domain impulse response H_{EEPN,t}_{_{c}}(f) and pulse response Hₜ_{_{c}}′(f) described above, which can be determined using Equations (5) to (7).

Optionally, after step S430, the process shown in FIG. 4 proceeds to step S440 where the apparatus performs one or more of the following operations on various distortions, noises, and system performance related to signal transmission in the coherent optical communication system based on the characteristics of EEPN: evaluation, compensation, monitoring, and optimization. For example, based on the frequency-domain impulse response H_{EEPN,t}_{_{c}}(f), a frequency-domain equalizer that directly compensates for CD/PMD can be designed and forward error correction (FEC) codes can be designed to improve the system's robustness to phase noise. Another example is that the laser phase noise and phase distortion introduced by transmission can be separated based on the phase spectrum of the frequency-domain impulse response H_{EEPN,t}_{_{c}}(f). Yet another example is that the system's tolerance to phase noise can be evaluated according to the impulse response H_{EEPN,t}_{_{c}}(f), and an appropriate modulation format can be selected. Additionally, the nonlinear coefficient of the optical fiber can be estimated by analyzing the nonlinear phase noise component in the frequency-domain impulse response H_{EEPN,t}_{_{c}}(f).

### Apparatus for Determining Characteristics of EEPN

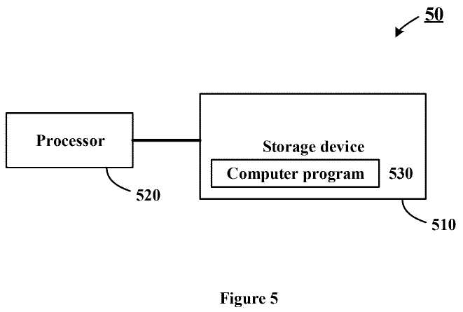

FIG. 5 is a block diagram illustrating an apparatus for determining characteristics of EEPN in a coherent optical communication system according to one exemplary embodiment of the present disclosure.

With reference to FIG. 5, the apparatus 50 comprises a storage device 510 and a processor 520 coupled to the storage device 510. The storage device 510 is configured to store a computer program 530 comprising computer instructions. The processor 520 is configured to execute the computer instructions to perform some or all of the method steps as shown in FIG. 4.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

It should be noted that the aforesaid embodiments are illustrative of this disclosure instead of restricting this disclosure, substitute embodiments may be designed by those skilled in the art without departing from the scope of the claims enclosed. The wordings such as “include”, “including”, “comprise” and “comprising” do not exclude elements or steps which are present but not listed in the description and the claims. It also shall be noted that as used herein and in the appended claims, the singular forms “a”, “an”, and “the” include plural referents unless the context clearly dictates otherwise. This disclosure can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names.

What is claimed is:

1. A method for determining characteristics of EEPN in a coherent optical communication system, comprising:
acquiring operation parameters associated with EEPN of the coherent optical communication system are acquired;
determining an accumulated dispersion coefficient for the coherent optical communication system based on the operation parameters; and
determining a frequency-domain impulse response based on the accumulated dispersion coefficient and a frequency-domain signal related to a local oscillator of the coherent optical communication system.

2. The method according to claim 1, wherein the operation parameters include dispersion coefficient, fiber length, and center optical frequency.

3. The method according to claim 1, wherein the operation parameters are stored as configuration parameters at the receiver-side of the system.

4. The method according to claim 2, wherein the accumulated dispersion coefficient is determined as:
$$k = π \cdot D \cdot l \cdot c \cdot {f}_{o}^{- 2}$$
where k denotes the accumulated dispersion coefficient, D denotes the dispersion coefficient, l denotes fiber length l, and f₀ denotes the center optical frequency.

5. The method according to claim 4, the frequency-domain impulse response is determined as:
$${H}_{EEPN , {t}_{c}} ( f ) = ( \frac{π}{k} ) \cdot {x}_{lo , {t}_{c}} ( f )$$
where H_{EEPN,t}_{_{c}}(f) denotes the frequency-domain impulse response, and x_{lo,t}_{_{c}}(f) denotes a frequency-domain signal related to the local oscillator.

6. The method according to claim 5, further comprising:
determining a pulse response based on the accumulated dispersion coefficient and the frequency-domain signal related to the local oscillator.

7. The method according to claim 6, the pulse response is determined as:
$${H}_{{t}_{c}}^{′} ( f ) \approx {H}_{EEPN , {t}_{c}} ( f ) \cdot {H}_{tx} ( f ) \cdot {e}^{j2 π {ft}_{c}}$$
$${H}_{tx} ( f ) = ℱ \{ {h}_{tx} ( t ) \}$$
where Hₜ_{_{c}}′(f) denotes the pulse response, Hₜₓ(f) denotes the frequency-domain response of the input pulse which is the Fourier transform of the input pulse hₜₓ(t), and e^{j2πft}^{_{c}} denotes a phase term.

8. The method according to claim 1, further comprising:
performing one or more of the following operations on distortions, noises, and system performance related to signal transmission in the coherent optical communication system based on the characteristics of EEPN: evaluation, compensation, monitoring, and optimization.

9. An apparatus for determining characteristics of EEPN in a coherent optical communication system, comprising:
a storage device configured to store a computer program comprising computer instructions; and
a processor coupled to the storage device and configured to execute the computer instructions to:
acquire operation parameters associated with EEPN of the coherent optical communication system are acquired;
determine an accumulated dispersion coefficient for the coherent optical communication system based on the operation parameters; and
determine a frequency-domain impulse response based on the accumulated dispersion coefficient and a frequency-domain signal related to a local oscillator of the coherent optical communication system.

10. The apparatus according to claim 9, wherein the operation parameters include dispersion coefficient, fiber length, and center optical frequency.

11. The apparatus according to claim 9, wherein the operation parameters are stored as configuration parameters at the receiver-side of the system.

12. The apparatus according to claim 10, wherein the accumulated dispersion coefficient is determined as:
$$k = π \cdot D \cdot l \cdot c \cdot {f}_{o}^{- 2}$$
where k denotes the accumulated dispersion coefficient, D denotes the dispersion coefficient, l denotes fiber length l, and f₀ denotes the center optical frequency.

13. The apparatus according to claim 12, the frequency-domain impulse response is determined as:
$${H}_{EEPN , {t}_{c}} ( f ) = ( \frac{π}{k} ) \cdot {x}_{lo , {t}_{c}} ( f )$$
where H_{EEPN,t}_{_{c}}(f) denotes the frequency-domain impulse response, and x_{lo,t}_{_{c}}(f) denotes a frequency-domain signal related to the local oscillator.

14. The apparatus according to claim 13, wherein the processor is configured to execute the computer instructions to:
determine a pulse response based on the accumulated dispersion coefficient and a frequency-domain signal related to the local oscillator.

15. The apparatus according to claim 14, the pulse response is determined as:
$${H}_{{t}_{c}}^{′} ( f ) \approx {H}_{EEPN , {t}_{c}} ( f ) \cdot {H}_{tx} ( f ) \cdot {e}^{j2 π {ft}_{c}}$$
$${H}_{tx} ( f ) = ℱ \{ {h}_{tx} ( t ) \}$$
where Hₜ_{_{c}}′(f) denotes the pulse response, Hₜₓ(f) denotes the frequency-domain response of the input pulse which is the Fourier transform of the input pulse hₜₓ(t), and e^{j2πft}^{_{c}} denotes a phase term.

16. The apparatus according to claim 9, wherein the processor is configured to execute the computer instructions to:
performing one or more of the following operations on distortions, noises, and system performance related to signal transmission in the coherent optical communication system based on the characteristics of EEPN: evaluation, compensation, monitoring, and optimization.
